(19) United States
(12) Patent Application Publication
(10) Pub. No.: US 2026/0113602 A1
(43) Pub. Date: Apr. 23, 2026

(54) SCHEDULING AND BEAM MANAGEMENT OF WIRELESS TRANSMISSIONS WITH COMMUNICATION PAYLOAD BASED ON SENSING REQUIREMENTS

(71) Applicants: Koninklijke KPN N.V., Rotterdam (NL); Nederlandse Organisatie Voor Toegepast-Natuurwetenschappelijk Onderzoek TNO, 's-Gravenhage (NL)

(72) Inventors: Kallol Das, Waddinxveen (NL); Ljupco Jorguseski, Rijswijk (NL); Remco Litjens, Voorschoten (NL); Haibin Zhang, Voorburg (NL)

(21) Appl. No.: 19/112,894

(22) PCT Filed: Sep. 26, 2023
(86) PCT No.: PCT/EP2023/076599

§ 371 Date: Mar. 18, 2025

(30) Foreign Application Priority Data
Oct. 4, 2022 (EP) 22199594
Feb. 9, 2023 (EP) 23155930

(51) Int. Cl. H04W 4/38; G01S 7/00; G01S 7/41; G01S 13/00; H04W 4/02; H04W 72/0453

(52) U.S. Cl. CPC H04W 4/38; G01S 7/006; G01S 7/411; G01S 13/003; H04W 4/025; H04W 72/0453

(57) ABSTRACT

A system (1) for sensing one or more objects (21-23) is configured to obtain sensing requirements for sensing the one or more objects, schedule frequency and time resources and/or determine beam characteristics of beams for transmissions of wireless communication signals which include communication pay load data to a specific further system (11-13) based on the sensing requirements, transmit the wireless communication signals to the further system on the scheduled frequency and time resources and/or via the beams with the determined beam characteristics, and obtain received signals upon transmitting the wireless communication signals. The received signals comprise received versions of the transmitted wireless communication signals and reflect an impact of the one or more objects on the transmitted wireless communication signals. The system is further configured to determine, or enable to determine, one or more physical properties of each of the objects based on the characteristics of the received signals.

### FIELD OF THE INVENTION

The invention relates to a system for sensing one or more objects based on characteristics of received signals.

The invention further relates to a method of sensing one or more objects based on characteristics of received signals.

The invention also relates to computer program products enabling a computer system to perform such a method.

### BACKGROUND OF THE INVENTION

Joint communication and sensing (JCAS) is considered as one of the important 6G candidate technologies in which the same system/network is used to perform both communication and sensing tasks. For example, a base station may be used as JCAS node and this base station can communicate with regular mobile terminals i.e. UEs (User Equipment), while being meanwhile used to sense/detect one or more objects like a flying drone. The JCAS node emits a radio signal, which is reflected by objects in the neighborhood and the reflected signals are received by a receiver and can be further used to detect the location, motion, shape and/or other characteristics of the objects. A JCAS node can also be a UE which emits the radio signal.

The paper “Enabling Joint Communication and Radar Sensing in Mobile Networks—A Survey” by J. A. Zhang et al., in IEEE Communications Surveys & Tutorials, vol. 24, no. 1, pp. 306-345, First quarter 2022, provides a survey of different technologies for realizing JCAS. With regard to the design of the radio signal, in general, the following options exist:
1. A dedicated sensing signal is used for the purpose of sensing, multiplexed with other sensing and/or communication signals in the time, frequency, and/or spatial domains. An advantage of this option is that the waveform is optimized for the purpose of sensing, which ultimately leads to a higher sensing performance. A disadvantage of this option is a relatively lower resource (time, frequency and power) efficiency.
2. A same (new) radio signal (waveform) is designed for both communication and sensing purposes, jointly taking into account the requirements of communication and sensing. An advantage of this option is a relatively high resource efficiency, since no resources need to be exclusively used for a dedicated sensing signal. A disadvantage of this option is that the performances of communication and sensing are compromised, since the requirements of communication and sensing differ significantly.
3. A conventional communication radio signal (waveform), designed for the purpose of communication, is additionally used for the purpose of sensing. An advantage of this option is that communication performance is guaranteed: there is no need to design a new waveform for the purpose of sensing. Since existing communication systems such as 5G and Wi-Fi may be used, existing hardware/devices may be used (possibly with a software update). A disadvantage of this option is a relatively low sensing performance, since communication signals are not designed/optimized for the purpose of sensing. In this option, common reference signals and/or signals with communication payload may be used for the purpose of sensing.

While options 2 and 3 have as advantage that they achieve a relatively high resource efficiency, since no resources need to be reserved for dedicated sensing signals, conventional implementations of these two options have as disadvantage that the sensing performance is compromised to a relatively high degree.

### SUMMARY OF THE INVENTION

It is a first objective of the invention to provide a system, which is able to sense one or more objects based on characteristics of received signals while achieving a high sensing performance.

It is a second objective of the invention to provide a method, which can be used to sense one or more objects based on characteristics of received signals while achieving a high sensing performance.

In a first aspect of the invention, a system for sensing one or more objects based on characteristics of received signals includes at least one receiver, at least one transmitter, and at least one processor configured to obtain sensing requirements for sensing the one or more objects, schedule frequency and time resources and/or determine beam characteristics of beams for transmissions of wireless communication signals to a specific further system based on the sensing requirements, the wireless communication signals including communication payload data, transmit, via the at least one transmitter, the wireless communication signals to the further system on the scheduled frequency and time resources and/or via the beams with the determined beam characteristics, upon transmitting the wireless communication signals, obtain received signals via the at least one receiver, the received signals comprising received versions of the transmitted wireless communication signals, the received signals reflecting an impact of the one or more objects on the transmitted wireless communication signals, and determine, or enable to determine, one or more physical properties of each of the one or more objects based on the characteristics of the received signals.

By scheduling the frequency and time resources for, and/or determining beam characteristics of beams for, transmissions of wireless communication signals based on sensing requirements, a higher sensing performance may be achieved. By scheduling the transmissions and/or determining the beam characteristics differently than conventionally would be done, this higher sensing performance may be achieved with no impact or relatively little impact on the communication performance. The reason for using wireless communication signals which include communication payload data is that most of the wireless communication signals in cellular networks are data payloads and therefore, this has a great benefit for the sensing performance.

The sensing requirements may, for example, specify one or more of: one or more targeted areas, one or more targeted directions, one or more targeted objects, targeted object velocities, targeted object sizes, and a sensing accuracy. The sensing accuracy may comprise a targeted range resolution, for example. The transmissions may use a waveform which has been designed for both communication and sensing or a waveform which has not been designed for sensing but only for communication. The latter has an advantage that existing communication technologies, e.g. LTE and/or 5G, may continue to be used.

The system may be a base station and the specific further system may be a UE or vice versa, for example. The system may comprise one node or multiple nodes. A node may be a UE or a base station, for example. The received signals may be received by a different node than the node which transmits the wireless communication signals. The physical properties of the one or more objects may include one or more of shape, motion, velocity, distance, orientation, pitch, and yaw, for example. The beam characteristics may include beamwidth, beam direction, and/or transmit power, for example. The scheduling may be performed before, after, or at the same time the beam characteristics are determined.

The sensing requirements may specify targeted object velocities and the at least one processor may be configured to determine a periodicity of the frequency and time resources based on the targeted object velocities. Typically, a shorter periodicity makes it possible to detect objects with higher velocities more accurately. A suitable periodicity of the frequency and time resources may be calculated based on a maximum object velocity that needs to be detected.

The sensing requirements may specify targeted object sizes and the at least one processor may be configured to determine an operating frequency of the frequency and time resources based on the targeted object sizes. The radar cross section of an object changes as a function of the size of the object relative to the wavelength of the sensing signal. By determining an operating frequency that is suitable for the object sizes that need to be detected, the detectability of the object may be improved. For example, a different operating frequency may be used for detecting humans than for detecting airplanes. If the targeted objects are not spherical, then the targeted aspect angles may additionally be taken into account.

The at least one processor may be configured to schedule the frequency and time resources and/or determine the beam characteristics further based on communication requirements. This may be used to ensure that communication requirements continue to be met and communication performance is not sacrificed too much. The beam characteristics may be determined such that the beam is not optimized for communication, but the communication payload is received by the further system with adequate communication performance and also covers the location of a targeted object or a targeted area (or part of a targeted area) or also covers a targeted direction (or part of a targeted direction).

The at least one processor may be configured to select a candidate beam from a plurality of candidate beams based on the communication requirements and the sensing requirements and determine the beam characteristics of one of the beams by selecting beam characteristics of the selected candidate beam. The plurality of candidate beams may be determined based on PMI feedback from the further system. The at least one processor of the system may be configured to choose a beam among the candidate beams with which a good trade-off between communication performance and sensing performance may be made.

The at least one processor may be configured to determine a beamwidth for each of the beams based on the sensing requirements. By using a wider beam than would conventionally be used, a targeted object, a targeted direction, or targeted area to the left or right and/or above or below of the further system may be covered by the beam.

The at least one processor may be configured to determine a beam direction for each of the beams based on the sensing requirements. By using a different beam direction than would conventionally be used, a targeted object, a targeted direction, or a targeted area to the left or right and/or above or below of the further system may be covered by the beam.

The at least one processor may be configured to determine a transmit power for each of the beams based on the sensing requirements. By using a larger transmit power than would conventionally be used, the range of the beam may be extended. The transmit power normally also depends on the available resources at the base station (e.g. the power budget).

The at least one processor may be configured to determine a first lobe of at least one of the beams based on communication requirements and a second lobe of the at least one of the beams based on the sensing requirements. This may help use the transmit power efficiently. The first lobe may be a main lobe and the second lobe may be a sidelobe or vice versa, for example. Alternatively, the first and second lobes may be equivalent lobes, for example.

The at least one processor may be configured to jointly determine beam characteristics for at least two of the beams based on the sensing requirements. For example, the beam characteristics of a first beam and the beam characteristics of a second beam may be determined such that a first part of a targeted area is covered by the first beam and a second part of the targeted area is covered by the second beam.

The at least one processor may be configured to jointly determine multiple beam characteristics per beam for at least one of the beams based on the sensing requirements. This may be used to increase sensing performance.

The at least one processor may be configured to select a frequency bandwidth based on the sensing requirements and/or select contiguous or non-contiguous frequency resources in dependence on the sensing requirements. By increasing the frequency bandwidth and/or the spectral span (by using non-contiguous frequency resources), the sensing performance may be improved.

The sensing requirements may specify a targeted range resolution and the at least one processor may be configured to select a first frequency bandwidth and/or contiguous frequency resources if the targeted range resolution does not exceed a threshold and select a second frequency bandwidth and/or non-contiguous frequency resources if the targeted range resolution exceeds the threshold, the first frequency bandwidth being smaller than the second frequency bandwidth and the contiguous frequency resources occupying a smaller spectral span than the non-contiguous frequency resources.

The at least one processor may be configured to obtain information indicative of a cell load and schedule the frequency and time resources and/or determine the beam characteristics further based on the cell load. The cell load may comprise a communication load and/or a sensing load, for example. The information may indicate the cell load by separately indicating at least two of communication load, sensing load, and total cell load, for example. The lower the communication load, the lower the opportunity for adjusting the wireless communication signals for the purpose of sensing may be and the lower the need to adjust wireless communication signals for the purpose of sensing rather than transmit dedicated sensing signals may be.

In a first example, if the communication load does not exceed a threshold, the frequency and time resources are not scheduled based on the sensing requirements or are scheduled to a lesser degree based on the sensing requirements than if the cell load lies in an optimal range for adjusting wireless communication signals. In this first example and/or in a second example, if the communication load does not exceed the/a threshold, the beam characteristics are not determined based on the sensing requirements or are determined based on the sensing requirements to a lesser degree than if the cell load lies in an optimal range for adjusting wireless communication signals.

Furthermore, adjusting the wireless communication signals may effectively make them worse from a communications perspective (degrade the communication quality) and consequently lead to an increase of the communication load, which is not desirable if the total cell load (e.g. the sum of the communication load and the sensing load) is already very high, for example.

In a third example, if the cell load exceeds a further threshold, e.g. if the total cell load is very high, the frequency and time resources are not scheduled based on the sensing requirements or are scheduled to a lesser degree based on the sensing requirements than if the cell load lies in an optimal range for adjusting wireless communication signals. In this third example and/or in a fourth example, if the cell load exceeds the/a further threshold, the beam characteristics are not determined based on the sensing requirements or are determined based on the sensing requirements to a lesser degree than if the cell load lies in an optimal range for adjusting wireless communication signals. If both the threshold and the further threshold are used, the further threshold is higher than the threshold.

If the frequency and time resources are scheduled to a lesser degree based on the sensing requirements, the wireless communication signals are adjusted less significantly for sensing purposes and kept closer to what is optimal from a communications perspective. If the beam characteristics are determined to a lesser degree based on the sensing requirements, the wireless communication signals are adjusted less significantly for sensing purposes and kept closer to what is optimal from a communications perspective.

The at least one processor may be configured to transmit, via the at least one transmitter, further wireless signals, the further wireless signals including dedicated sensing signals, upon transmitting the further wireless signals, obtain further received signals via the at least one receiver, the further received signals comprising received versions of the transmitted further wireless signals, the further received signals reflecting an impact of the one or more objects on the transmitted further wireless signals, and determine, or enable to determine, the one or more physical properties of each of the one or more objects further based on characteristics of the further received signals. This may be used to increase the sensing performance even further without affecting communication performance, in particular in the case of low communication traffic load.

The at least one processor may be configured to transmit the further wireless signals in time-frequency resources, e.g. periods, in which no transmissions of wireless communication signals to the specific further system or to other systems have been scheduled. However, it is not required that the dedicated sensing signals use idle time-frequency resources, but can also reuse time-frequency resources in a spatial multiplexing fashion, e.g. when a communications signal is beamformed in one direction, a dedicated sensing signal could potentially be transmitted in a different direction, using the same time-frequency resources. Such concurrent same-resource transmissions do need to share transmit power then. So in particular the transmit power of the existing communications signal would be reduced.

The at least one processor may be configured to obtain information indicative of a cell load and transmit the further wireless signals in dependence on the cell load. The cell load may comprise a communication load and/or a sensing load, for example. In an example, the further wireless signals are not transmitted if the communication load exceeds a threshold. The higher the communication load, the higher the need to adjust wireless communication signals for the purpose of sensing rather than transmit dedicated sensing signals (and the higher the opportunity for adjusting the wireless communication signals for the purpose of sensing).

In a second aspect of the invention, a data processing system for determining one or more physical properties of each of one or more objects includes at least one processor configured to receive sensing data from a system as described above, said sensing data comprising characteristics of the received signals obtained by the system, and determine the one or more physical properties of each of the one or more objects based on the characteristics of the received signals.

In a third aspect of the invention, a telecommunications network comprises the system and the data processing system.

In a fourth aspect of the invention, a method of sensing one or more objects based on characteristics of received signals includes obtaining sensing requirements for sensing the one or more objects, scheduling frequency and time resources for and/or determining beam characteristics of beams for transmissions of wireless communication signals to a specific further system based on the sensing requirements, the wireless communication signals including communication payload data, transmitting the wireless communication signals to the further system on the scheduled frequency and time resources and/or via the beams with the determined beam characteristics. Upon transmitting the wireless communication signals, the method further includes obtaining received signals, the received signals comprising received versions of the transmitted wireless communication signals, the received signals reflecting an impact of the one or more objects on the transmitted wireless communication signals being impacted by the one or more objects, and determining, or enabling to determine, one or more physical properties of each of the one or more objects based on the characteristics of the received signals. The method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least a first software code portion, the first software code portion, when executed or processed by a computer, being configured to perform executable operations for sensing one or more objects based on characteristics of received signals.

The executable operations comprise obtaining sensing requirements for sensing the one or more objects, scheduling frequency and time resources for and/or determining beam characteristics of beams for transmissions of wireless communication signals to a specific further system based on the sensing requirements, the wireless communication signals including communication payload data, transmitting the wireless communication signals to the further system on the scheduled frequency and time resources and/or via the beams with the determined beam characteristics, upon transmitting the wireless communication signals, obtaining received signals, the received signals comprising received versions of the transmitted wireless communication signals, the received signals reflecting an impact of the one or more objects on the transmitted wireless communication signals being impacted by the one or more objects, and determining, or enable to determine, one or more physical properties of each of the one or more objects based on the characteristics of the received signals.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s).

It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a flow diagram of a first embodiment of the method;

FIG. 2 illustrates the use of a wider spectral span or a wider bandwidth in a second embodiment of the method;

FIG. 3 illustrates the use of beam adjustment based on sensing requirements in a third embodiment of the method;

FIG. 4 illustrates the use of multiple beams to sense objects in a fourth embodiment of the method;

FIG. 5 shows a relationship between the radar cross section of a spherical object and the size of the object;

FIG. 6 is a block diagram of a first embodiment of the system;

FIG. 7 is a block diagram of a second embodiment of the system;

FIG. 8 is a block diagram of a third embodiment of the system;

FIG. 9 is a block diagram of a fourth embodiment of the system; and

FIG. 10 is a block diagram of an exemplary data processing system for performing the method of the invention.

Corresponding elements in the drawings are denoted by the same reference numeral.

### DETAILED DESCRIPTION OF THE DRAWINGS

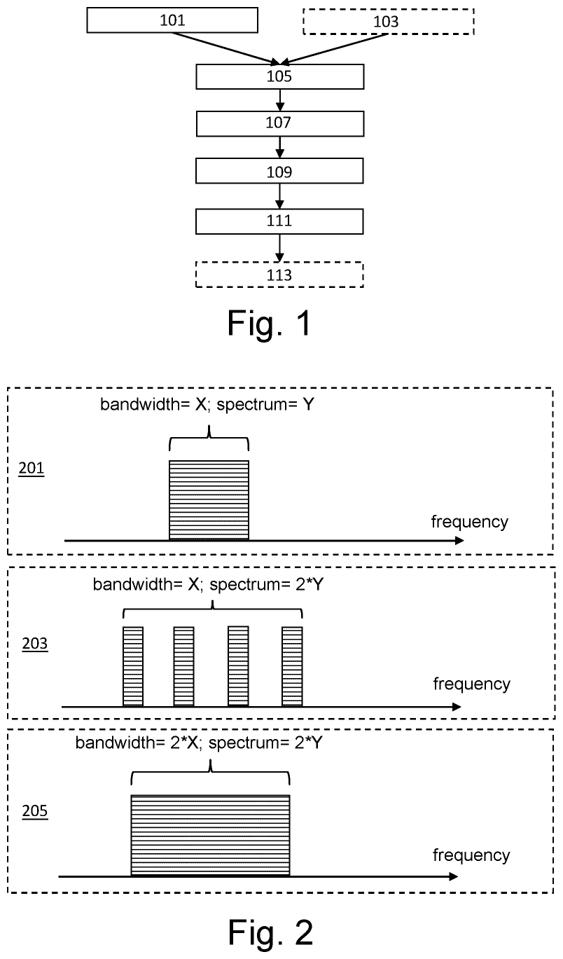

A first embodiment of the method of sensing one or more objects based on characteristics of received signals is shown in FIG. 1. A step 101 comprises obtaining sensing requirements for sensing one or more objects. The sensing requirements may specify one or more of: one or more targeted areas, one or more targeted directions, one or more targeted objects, targeted object velocities, targeted object sizes, and a sensing accuracy. An optional step 103 comprises obtaining communication requirements. Steps 101 and 103 may be performed in an information collection phase. Other information may also be collected in this information collection phase, e.g. the (usual) CSI feedback of the UEs and the amount of available resources (e.g. power, spectrum). For example, information indicative of a cell load may be collected in the information collection phase. The cell load may comprise a communication load and/or a sensing load, for example.

Next, radio resource management is performed in a step 105. Step 105 comprises scheduling frequency and time resources for and/or determining beam characteristics of beams for transmissions of wireless communication signals to a specific further system based on the sensing requirements obtained in step 101. The wireless communication signals include communication payload data. If communication requirements were obtained in step 103, the frequency and time resources are scheduled and/or the beam characteristics are determined based on both the sensing requirements obtained in step 101 and the communication requirements obtained in step 103.

In other words, the communication payload beams are finetuned (e.g. in terms of scheduling, power assignment and beam shaping) to provide better sensing performance with an acceptably modest sacrifice in terms of a reduced communication performance and resource usage/efficiency. If information indicative of a cell load was collected in the information collection phase, the frequency and time resources may further be scheduled based on the cell load in step 105 and/or the beam characteristics may further be determined based on the cell load in step 105.

The cell load may comprise a communication load and/or a sensing load, for example. The information may indicate the cell load by separately indicating at least two of communication load, sensing load, and total cell load, for example. The lower the communication load, the lower the opportunity for adjusting the wireless communication signals for the purpose of sensing may be and the lower the need to adjust wireless communication signals for the purpose of sensing rather than transmit dedicated sensing signals may be.

In a first example, if the communication load does not exceed a threshold, the frequency and time resources are not scheduled based on the sensing requirements or are scheduled to a lesser degree based on the sensing requirements than if the cell load lies in an optimal range for adjusting wireless communication signals. In this first example and/or in a second example, if the communication load does not exceed the/a threshold, the beam characteristics are not determined based on the sensing requirements or are determined based on the sensing requirements to a lesser degree than if the cell load lies in an optimal range for adjusting wireless communication signals.

Furthermore, adjusting the wireless communication signals may effectively make them worse from a communications perspective (degrade the communication quality) and consequently lead to an increase of the communication load, which is not desirable if the total cell load (e.g. the sum of the communication load and the sensing load) is already very high, for example.

In a third example, if the cell load exceeds a further threshold, e.g. if the total cell load is very high, the frequency and time resources are not scheduled based on the sensing requirements or are scheduled to a lesser degree based on the sensing requirements than if the cell load lies in an optimal range for adjusting wireless communication signals. In this third example and/or in a fourth example, if the cell load exceeds the/a further threshold, the beam characteristics are not determined based on the sensing requirements or are determined based on the sensing requirements to a lesser degree than if the cell load lies in an optimal range for adjusting wireless communication signals. If both the threshold and the further threshold are used, the further threshold is higher than the threshold.

If the frequency and time resources are scheduled to a lesser degree based on the sensing requirements, the wireless communication signals are adjusted less significantly for sensing purposes and kept closer to what is optimal from a communications perspective. If the beam characteristics are determined to a lesser degree based on the sensing requirements, the wireless communication signals are adjusted less significantly for sensing purposes and kept closer to what is optimal from a communications perspective.

A step 107 comprises transmitting the wireless communication signals to the further system on the scheduled frequency and time resources and/or via the beams with the determined beam characteristics. As mentioned previously, in general, the following options exist with regard to the design of the radio signal:
1. A dedicated sensing signal is used for the purpose of sensing, multiplexed with other sensing and/or communication signals in the time, frequency, and/or spatial domains.
2. A same (new) radio signal (waveform) is designed for both communication and sensing purposes, jointly taking into account the requirements of communication and sensing.
3. A conventional communication radio signal (waveform), designed for the purpose of communication, is additionally used for the purpose of sensing.

The wireless communication signals transmitted in step 107 may either be the signals mentioned in option 2 or the signals mentioned in option 3. Next, the sensing is performed in steps 109 and 111. Step 109 comprises obtaining received signals. The received signals comprise received versions of the transmitted wireless communication signals. The received signals reflect an impact of the one or more objects on the transmitted wireless communication signals.

Step 111 comprises determining one or more physical properties of each of the one or more objects based on the characteristics of the received signals obtained in step 109. The physical properties of the one or more objects may include one or more of shape, motion, velocity, distance, orientation, pitch, and yaw, for example. Step 111 may be performed by the same node or nodes as step 109 or by a different node. In the latter case, the one or more nodes that perform step 109 perform an additional step which comprises enabling this different node to determine one or more physical properties of each of the one or more objects based on the characteristics of the received signals obtained in step 109, e.g. by transmitting sensing data which comprises characteristics of the received signals obtained in step 109.

A step 113 is performed optionally after step 111. Optional step 113 comprises assessing the achieved sensing performance. If the targeted sensing and/or communication performance is not reached, step 105 may be repeated and the method may proceed as shown in FIG. 1. The results of the assessment may then be taken into account in step 105.

In alternative embodiments of the method, step 105 is implemented in a specific manner. For example, in a second embodiment of the method, step 105 comprises selecting a frequency bandwidth based on the sensing requirements and/or selecting contiguous or non-contiguous frequency resources in dependence on the sensing requirements obtained in step 101. For example, the sensing requirements obtained in step 101 may specify a targeted range resolution and step 105 may comprise selecting a first frequency bandwidth and/or contiguous frequency resources if the targeted range resolution does not exceed a threshold and selecting a second frequency bandwidth and/or non-contiguous frequency resources if the targeted range resolution exceeds the threshold. The first frequency bandwidth is smaller than the second frequency bandwidth and the contiguous frequency resources occupy a smaller spectral span than the non-contiguous frequency resources.

This implementation may be used to improve range resolution, i.e. the ability to distinguish between two or more targets which are very close to each other. Mathematically, range resolution can be represented as

$${S}_{r} \geq \frac{c}{2 B} ,$$

where c is the speed of light and B the (effective) pulse/signal bandwidth. By improving range resolution, spatial resolution is improved. The combination of range resolution and angular resolution defines the spatial resolution of the system. Angular resolution is the minimum distance between two equally large targets at the same range which radar is able to distinguish and separate from each other.

By using non-contiguous frequency resources, the spectral span may be increased without a (proportional) increase in bandwidth. At a given scheduling moment (e.g. TTI), the radio resource manager may intentionally widen the spectral span of the communication payload beam, aiming at higher sensing performance. FIG. 2 illustrates that the use of a wider spectral span or a wider bandwidth of the radio signal will generally lead to higher sensing performance.

In scenario 201, contiguous frequency resources with a bandwidth X and a spectrum Y are used. In scenario 203, the spectral span is widened to 2*Y without widening the bandwidth by using non-contiguous frequency resources. In scenario 205, the bandwidth is widened to 2*X and thereby the used spectrum is widened as well. As contiguous frequency resources are used in scenario 205, the spectral span is 2*Y. In the example of FIG. 2, the non-contiguous frequency resources have a uniform spacing in between in scenario 203. However, the spacing between the non-contiguous frequency resources may also be non-uniform.

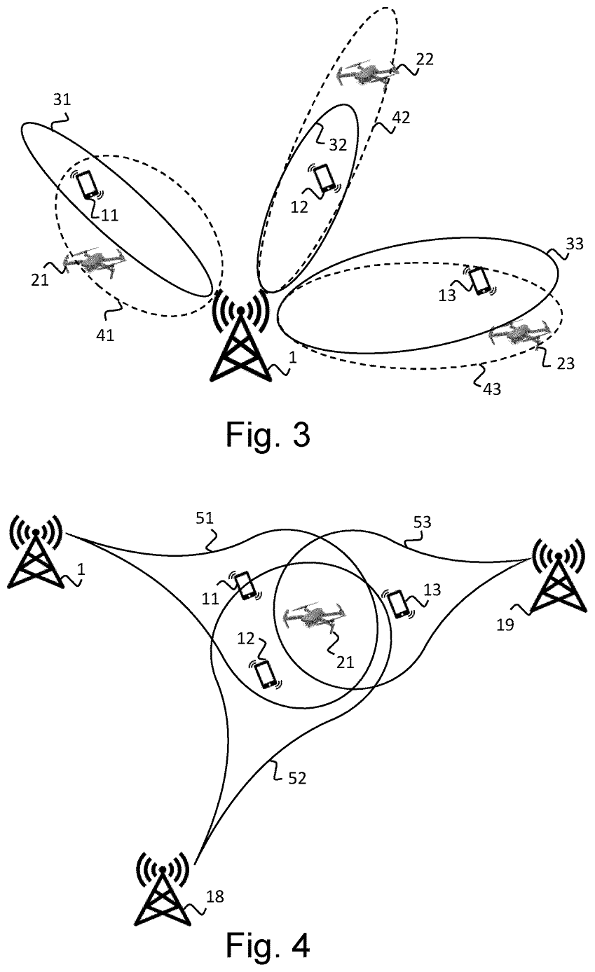

In the same embodiment or in an alternative embodiment, step 105 may comprise determining a beamwidth and/or a beam direction and/or a transmit power for each of the beams based on the sensing requirements obtained in step 101. This is illustrated with the help of FIG. 3. FIG. 3 shows a base station 1 which services three UEs 11-13. For the transmission of the communication payload, radio beams would conventionally be configured for the purpose of communication with certain QoS requirements, e.g. to maximize the user throughput and/or minimize the latency.

In conventional methods, sensing requirements are not taken into account when determining the time-frequency and power resources assigned to the radio beams and the beam characteristics (e.g. beam direction, width and pattern). Beams 31-33 are configured/scheduled to fulfil only the communication needs of UEs 11-13, respectively. The beams 31-33 cannot be effectively used to sense the objects 21-23, as the beams 31-33 do not cover the objects 21-23 with strong enough signal strength and the objects 21-23 can therefore not be sensed or only be sensed with unacceptable sensing accuracy.

FIG. 3 further shows how the normal communication beams 31-33 may be (re-) configured for better sensing performance:
Beam 31 is (re-) configured as beam 41, which has a wider beamwidth, in order to sense object 21 (or any object nearby object 21) with better sensing performance. The coverage distance of beam 31 is sacrificed, but under the condition that the communication performance with UE 11 is still above a threshold (e.g. GBR—Guaranteed Bit Rate).
Beam 32 is (re) configured as beam 42, which has a higher power, in order to sense object 22 (or any object nearby object 22) with better sensing performance. The communication performance with UE 12 is not sacrificed (improved even), but the higher power assignment to beam 42 implies that other concurrently transmitted beams may see their transmit power reduced. In this case, the local information (e.g. available power) at the base station 1 may be used to estimate the extra available power budget that may be used without making it impossible for the other concurrently transmitted beams to be strong enough to achieve a communication performance above a threshold.
Beam 33 is reconfigured as beam 43, which has a different beam direction. The direction of beam 43 has been tuned so that object 23 can be sensed at the cost of a reduced communication performance with UE 13 (but still above a threshold (e.g. GBR)).

In case of MU-MIMO communication, it is preferably ensured that the above-mentioned beam reconfiguration does not lead to too much interference to the beams of other UEs in cells sharing the same time-frequency resources. Information from the neighboring base stations regarding the use of spectrum may be used to facilitate inter-cell interference awareness and inter-cell interference cancellation.

In the example of FIG. 3, each of the reconfigured beams 41-43 only differs from the normal beam with respect to one beam characteristic. Alternatively, two or more beam characteristics (e.g. beam direction, width, power) may be jointly adjusted for better sensing performance. In other words, step 105 may comprise jointly determining multiple beam characteristics per beam for at least one of the beams based on the sensing requirements.

There might be multiple candidate beams for communication with a certain UE, e.g. based on the PMI feedback from the UE. The radio resource manager may choose a beam among the candidate beams, with which a good trade-off can be made between communication performance and sensing performance. In other words, step 105 may comprise selecting a candidate beam from a plurality of candidate beams based on the communication requirements and the sensing requirements and determine the beam characteristics of one of the beams by selecting beam characteristics of the selected candidate beam.

Step 105 may also comprise determining a first lobe of at least one of the beams based on communication requirements and a second lobe of the at least one of the beams based on the sensing requirements. For example, a communication payload beam may be configured so that the main lobe of the beam steers to the UE, while a sidelobe of the beam steers to the targeted object. In this case, information on the sensing direction might be more relevant than where the targeted object is exactly located.

Alternatively or additionally, step 105 may comprise jointly determining beam characteristics for at least two of the beams based on the sensing requirements. The use of more than one beam may increase the sensing accuracy, especially when performing initial object detection. For example, three or more beams may be directed towards a to-be-sensed object/target area to determine its initial location, as shown in FIG. 4.

In the example of FIG. 4, there is one object to be sensed: target object 21. Three base stations 1, 18, and 19, transmit beams 51, 52, and 53, respectively, towards UEs 11, 12, and 13, respectively, to detect the target object 21. Beams 51, 52, and 53 have been jointly determined based on the sensing requirements, e.g. the targeted area. In the example of FIG. 4, all beams are transmitted by base stations. Alternatively, one or more of the beams may be transmitted by one or more UEs (e.g. sidelink beams) instead of by one or more base stations.

After determining the target object's initial location, it might not be necessary to use this many beams to track the detected object (e.g. by using ranging information from one base station).

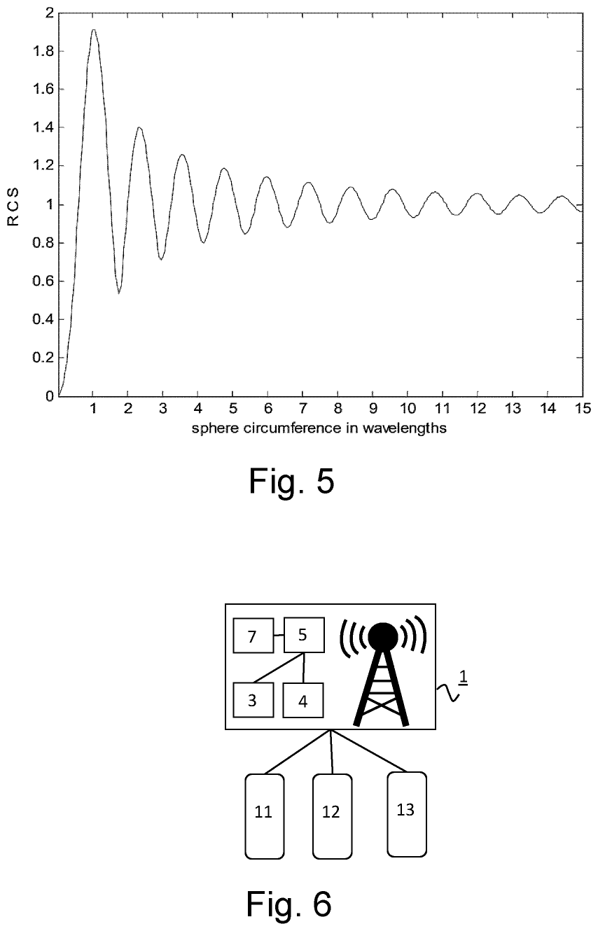

In the same embodiment or in an alternative embodiment, the sensing requirements obtained in step 101 may specify targeted object sizes and step 105 may comprise determining an operating frequency of the frequency and time resources based on the targeted object sizes obtained in step 101. As shown in FIG. 5, the Radar Cross Section (RCS) of an object changes as a function of the size of the object relative to the wavelength of the sensing signal. In FIG. 5, the radar cross section is between 0 and 2 square meters.

By determining an operating frequency that is suitable for the object sizes that need to be detected, the detectability of the object may be improved. For example, a different operating frequency may be used for detecting humans than for detecting airplanes. The sensing requirements may include a task description and performance requirements. The task description may indicate the ‘where’ (e.g. in a well-defined area around Amsterdam), ‘when’ (e.g. today between 2-4 pm), and ‘what’ (e.g. a flying drone/device of measurements [H (height), B (breadth), L (length)] with H_{MIN}<H<H_{MAX}, B_{MIN}<B<B_{MAX}, L_{MIN}<L<L_{MAX}). The performance requirements may prescribe detection of the target object within x seconds of its entering the area or of initiating the sensing task, successful detection probability >y, and/or false alarm rate <z, for example.

Specific values for these parameters (related to the task description and the performance requirements) may be provided by an external application. Based on these parameter values, the system may determine the best operating frequency (among the ones it has access to). If the targeted objects are not spherical, then the targeted aspect angles may additionally be taken into account while determining the operating frequency. Thanks to the multiple frequency carriers of the cellular communication systems, unlike traditional radar systems, a JCAS system has more flexibility in selecting operating frequency.

The Signal-to-Noise Ratio (SNR) with which the objects can be detected depends on the RCS of the objects. This SNR may be calculated with the following equation:

$$SNR = \frac{( \frac{{P}_{T} {G}_{T} {G}_{R} {λ}^{2} {F}_{T}^{2} {F}_{R}^{2}}{{( 4 π )}^{3} {kT}_{s} {B}_{n} {L}_{T} {L}_{R}} )}{{R}_{T}^{2} {R}_{R}^{2}} σ$$

### Where

| | |
|---|---|
| σ | the (bistatic) RCS |
| k | Boltzmann constant |
| Tₛ | equivalent system temperature |
| Bₙ | the (noise) bandwidth |
| λ | Central wavelength |
| P_{T} | Tx power |
| G_{T}, G_{R} | Antenna gains |
| F_{T}, F_{R} | Form factors |
| L_{T}, L_{R} | Losses |
| R_{T}, R_{R} | Distances |

For a given parameter set and some detection performance based on SNR, a range corresponding to a certain RCS may be calculated. Parameters may be adjusted to obtain a higher SNR and achieve a certain probability of detection. In practice, there is a window of approximately 10 dB between no detection at all, and a very high probability of detection. The above equation is a bistatic equation. By taking T=R (i.e. G_{T}=G_{R}, F_{T}=F_{R}, L_{T}=L_{R}, and R_{T}=R_{R}), the equation will yield the monostatic case.

In the same embodiment or in an alternative embodiment, the sensing requirements obtained in step 101 may specify targeted object velocities and step 105 may comprise determining a periodicity of the frequency and time resources based on the targeted object velocities obtained in step 101. This periodicity may be determined by determining a Pulse Repetition Frequency (PRF) based on the maximum unambiguous radial velocity (v_{r,max}) to be detected, for example. By transmitting a signal each other period (so alternately), pulses are created. Each period may correspond to a TTI, time slot, mini-slot, or (e.g. OFDM) symbol, for example. For instance, a signal may be transmitted every other TTI/OFDM symbol depending on the detectable maximum velocity. The PRF may be calculated by using the following equation:

$${v}_{r , max} = \frac{λ}{4} PRF$$

The maximum unambiguous range (Rₘₐₓ) that can be detected is also related to this factor and can be calculated by using the following equation:

$${R}_{max} = \frac{c}{2 PRF}$$

For example, if the sensing requirements specify that targets with a maximum radial velocity of 200 km/h in x-band (10 GHz) need to be detected, it may be determined that a PRF of ˜74K per second (74 kHz) is needed. With a PRF of ˜74 kHz, a pulse should be transmitted at least each 13.5 μs (approximately). In this case, a signal/pulse may be transmitted each other mini-slot or each other symbol, for example.

The PRF of ˜74 kHz corresponds to a maximum range of 2.2 km. If a monotone is transmitted with this PRF, this resolution of 2.2 km can be obtained for one target, as one target is detected per pulse. If ten targets need to be detected along the radial axis, the bandwidth of the pulse must also increase, which can be achieved by adapting the time-frequency resources by the same factor and hence 10 times larger. However, because the bandwidth was increased, the total signal to noise ratio would be lower and an adjustment would need to be made for this reduction, either by increasing the transmission power or by increasing the duration of the transmissions.

If is not possible to use the PRF that is determined based on the maximum unambiguous radial velocity, because this PRF would be too large, to prevent that the maximum unambiguous range would become smaller than required, sensing may be repeated at a different central frequency. By combining both measurements, the maximum unambiguous range may be increased.

In the same embodiment or in an alternative embodiment, step 105 may comprise delaying a transmission of a wireless communication signal to a specific further system such that the beam is only transmitted when there is a need for (better) sensing. This is applicable for delay-tolerant communications. The transmission of the communication payload may also be spread over two or more separate transmissions, even when it would be possible to transmit the communication payload in a single transmission, if there is a need for (better) sensing.

The method of FIG. 1 may be used in a standalone way, i.e. purely opportunistic use of communication payload transmission for sensing, where necessary and possible. Additionally, when there is no communication payload to be transmitted, but there is a sensing task, the gap created by lack of beams with communication payload to specific further systems, e.g. UEs, could be filled by using further wireless signals, e.g. dedicated sensing signals. For example, the method of FIG. 1 may further comprise:
transmitting further wireless signals, e.g. in time-frequency resources in which no transmissions of wireless communication signals to the specific further system or to other systems have been scheduled. The further wireless signals include dedicated sensing signals;
obtaining further received signals upon transmitting the further wireless signals. The further received signals comprise received versions of the transmitted further wireless signal and reflect an impact of the one or more objects on the transmitted further wireless signals; and
determining the one or more physical properties of each of the one or more objects further based on characteristics of the further received signals.

Whether dedicated sensing signals are transmitted may depend on a cell load. The cell load may comprise a communication load and/or a sensing load, for example. In an example, the further wireless signals are not transmitted if the communication load exceeds a threshold. The higher the communication load, the higher the need to adjust wireless communication signals for the purpose of sensing rather than transmit dedicated sensing signals (and the higher the opportunity for adjusting the wireless communication signals for the purpose of sensing).

FIG. 6 is a block diagram of a first embodiment of the system for sensing one or more objects based on characteristics of received signals. In this first embodiment, the system is a base station: base station 1. The base station 1 may be a 5G gNodeB base station, for example. The base station 1 may comprise a plurality of distributed units that share a common centralized unit in a Centralized RAN (C-RAN) architecture. Three UEs 11, 12, and 13, e.g., 5G UEs, are connected to the base station 1.

The base station 1 comprises a receiver 3, a transmitter 4, a processor 5, and a memory 7. The processor 5 is configured to obtain sensing requirements for sensing the one or more objects and schedule frequency and time resources and/or determine beam characteristics of beams for transmissions of wireless communication signals to a specific further system, e.g. UE 11, 12, or 13, based on the sensing requirements. The wireless communication signals include communication payload data.

The processor 5 is further configured to transmit, via the transmitter 4, the wireless communication signals to the further system, e.g. UE 11, 12, or 13, on the scheduled frequency and time resources and/or via the beams with the determined beam characteristics, and obtain received signals via the receiver 3 upon transmitting the wireless communication signals. The received signals comprise received versions of the transmitted wireless communication signals and reflect an impact of the one or more objects on the transmitted wireless communication signals. The processor 5 is further configured to determine one or more physical properties of each of the one or more objects based on the characteristics of the received signals.

For example, besides the regular communication requirements, a radio resource manager of the base station 1 may also take the sensing requirements (e.g. targeted area, targeted direction, targeted objects, required sensing accuracy) into account in scheduling (considering time-frequency and power resources assigned to the beams) and/or beam management (e.g. (re-) configuration of beam direction, width and pattern).

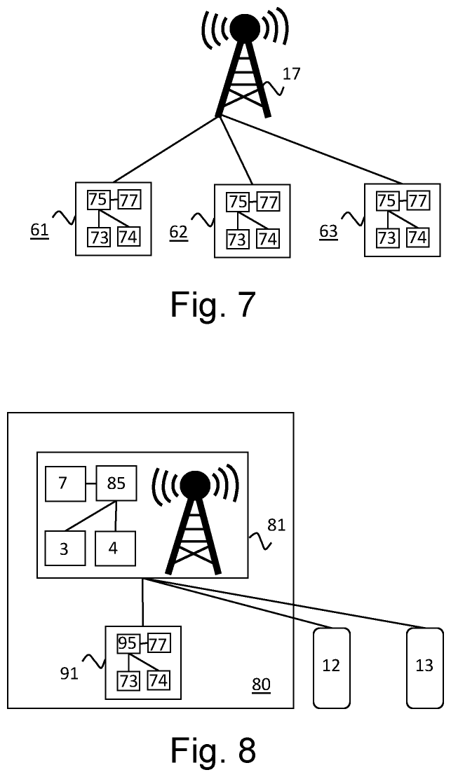

FIG. 7 is a block diagram of a second embodiment of the system. In this second embodiment, the system comprises a UE. FIG. 7 shows three systems: UEs 61, 62, and 63. In an alternative embodiment, a single system comprises the three UEs. In this alternative embodiment, one of the three UEs or another node, e.g. the base station 17, may receive the characteristics of the received signals from the (other) UEs and determine the one or more physical properties of each of the one or more objects based on these characteristics. This other node may be part of the system.

In the embodiment of FIG. 7, the UEs 61, 62, and 63 each comprise a receiver 73, a transmitter 74, a processor 75, and a memory 77. The processor 75 is configured to obtain sensing requirements for sensing the one or more objects and schedule frequency and time resources and/or determine beam characteristics of beams for transmissions of wireless communication signals to a specific further system, e.g. base station 17 or one of the other UEs, based on the sensing requirements. The wireless communication signals include communication payload data.

The processor 75 is further configured to transmit, via the transmitter 74, the wireless communication signals to the further system, e.g. base station 17 or one of the other UEs, on the scheduled frequency and time resources and/or via the beams with the determined beam characteristics, and obtain received signals via the receiver 73 upon transmitting the wireless communication signals. The received signals comprise received versions of the transmitted wireless communication signals and reflect an impact of the one or more objects on the transmitted wireless communication signals. The processor 75 is further configured to determine one or more physical properties of each of the one or more objects based on the characteristics of the received signals.

FIG. 8 is a block diagram of a third embodiment of the system. In this third embodiment, the system comprises a base station 81 and at least a UE 91. In the example of FIG. 8, UEs 12 and 13 are not capable of performing sensing, but in an alternative embodiment, the system may comprise one or more additional base stations and/or one or more additional UEs.

The base station 81 comprises a receiver 3, a transmitter 4, a processor 85, and a memory 7. The UE 91 comprises a receiver 73, a transmitter 74, a processor 95, and a memory 77. The processor 85 is configured to obtain sensing requirements for sensing the one or more objects and schedule frequency and time resources and/or determine beam characteristics of beams for transmissions of wireless communication signals to a specific further system, e.g. UE 12 or 13, based on the sensing requirements. The wireless communication signals include communication payload data.

The processor 85 is further configured to transmit, via the transmitter 4, the wireless communication signals to the further system, e.g. UE 12 or 13, on the scheduled frequency and time resources and/or via the beams with the determined beam characteristics, and obtain received signals via the receiver 73 of UE 91 upon transmitting the wireless communication signals. The received signals comprise received versions of the transmitted wireless communication signals and reflect an impact of the one or more objects on the transmitted wireless communication signals.

The processor 85 is further configured to receive the characteristics of the signals received by the UE 91 from the UE 91 and determine one or more physical properties of each of the one or more objects based on these characteristics.

In the embodiment of FIG. 8, the base station 81 does not perform sensing itself, i.e. no physical properties of the objects are determined based on the characteristics of signals received directly by the base station 81 itself. In an alternative embodiment, the base station 81 does perform sensing itself. In this alternative embodiment, the processor 85 may be configured in a similar manner as processor 5 of base station 1 of FIG. 6. However, unlike the base station 1 of FIG. 6, the base station 81 of FIG. 8 receives the characteristics of signals received by a UE from the UE (UE 91) and determines the one or more physical properties of each of the one or more objects further based on these characteristics.

In the embodiments shown in FIGS. 6 and 8, the base stations 1 and 81 comprise one processor. In an alternative embodiment, one or more of the base stations 1 and 81 comprise multiple processors. The processor of the base stations 1 and 81 may be a general-purpose processor, e.g., an Intel or an AMD processor, or an application-specific processor, for example. The processor may comprise multiple cores, for example. The processor may run a Unix-based or Windows operating system, for example. The memory 7 may comprise solid state memory, e.g., one or more Solid State Disks (SSDs) made out of Flash memory, or one or more hard disks, for example.

The receiver 3 and the transmitter 4 may use one or more wireless communication technologies such as Wi-Fi, LTE, and/or 5G New Radio to communicate with UEs 11-13 and UE 91. The receiver 3 and the transmitter 4 may use one or more communication technologies (wired or wireless) to communicate with other systems in the radio access network or in the core network, for example. The receivers and the transmitter may be combined in a transceiver. The base stations may comprise other components typical for a component in a mobile communication network, e.g., a power supply. In the embodiments shown in FIGS. 6 and 8, each of the base stations may comprise a single unit or a central unit and one or multiple distributed units, for example.

In the embodiments shown in FIGS. 7 and 8, the UEs 61-63 and 91 comprise one processor 75 or 95. In an alternative embodiment, one or more of the UEs 61-63 and 91 comprise multiple processors. The processors 75 and 95 may be general-purpose processors, e.g., ARM or Qualcomm processors, or application-specific processors. The processors 75 and 95 may run Google Android or Apple iOS as operating system, for example.

The receiver 73 and the transmitter 74 of the UEs 61-63 and 91 may use one or more wireless communication technologies such as Wi-Fi, LTE, and/or 5G New Radio to communicate with base stations, for example. The receiver 73 and the transmitter 74 may be combined in a transceiver. The UEs 61-63 and 91 may comprise other components typical for user equipment, e.g., a battery and/or a power connector.

A UE may also be referred to by those skilled in the art as a mobile station (MS), a subscriber station, a mobile unit, a subscriber unit, a wireless unit, a wireless terminal, a wireless device, a wireless communications device, a remote device, a mobile subscriber station, an access terminal (AT), a mobile terminal, a remote terminal, a handset, a terminal, a user agent, a mobile client, a client, or some other suitable terminology.

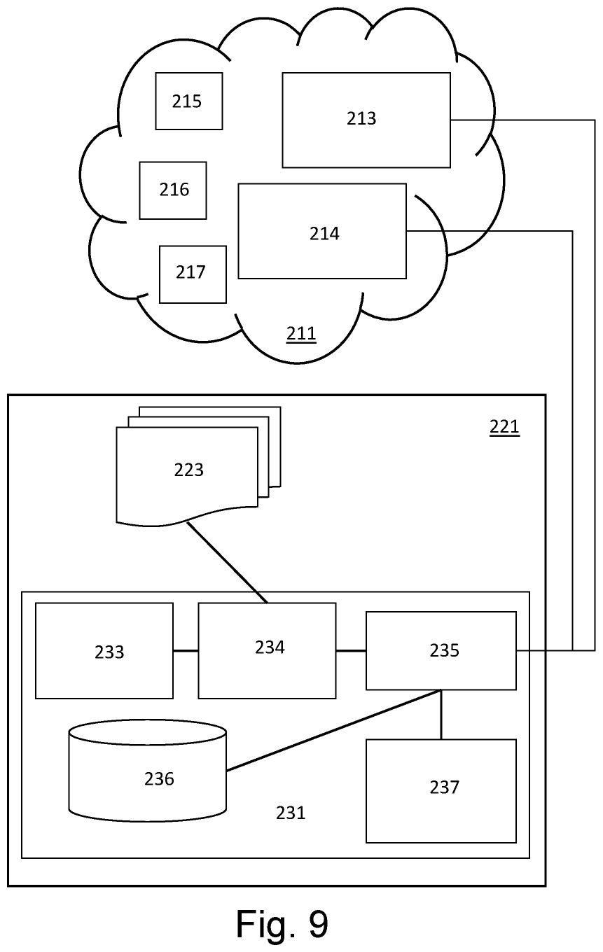

FIG. 9 is a block diagram of a fourth embodiment of the system. FIG. 9 shows a cellular network which includes a (cloud/distributed-) Radio Access Network ((C/D-) RAN) 221 and a Core Network (CN) 211. The RAN 221 includes User Equipment (UEs) 223 and a Base Station (BS) 231. The CN 211 includes different CN-specific functions including the Communication Application Function (C-AF) 214 and the Sensing Application Function (S-AF) 213. The above mentioned application functions (i.e. C-AF 214 and S-AF 213) take care of the corresponding applications.

The cellular network may be a 5G network, the RAN 221 may be a 5G New Radio RAN, and the BS 231 may be a 5G gNodeB base station, for example. The BS 231 may comprise a plurality of distributed units that share a common centralized unit in a Centralized RAN (C-RAN) architecture, for example.

The BS 231 is given the task of sensing upon getting a trigger for this sensing task from the S-AF 213. The BS 231 then performs the method shown in FIG. 1 by using different units/functions: information collector 235, sensing data collector 234, sensing data processor 233, and radio resource manager 237. In the embodiment of FIG. 9, the information collector 235 and the sensing data processor 233 reside inside the BS 231. In an alternative embodiments, these units/functions are implemented outside of the BS 231, e.g. in a separate device.

The information collector 235 collects information from relevant entities in the network in the information collection phase (which includes steps 101 and 103 of FIG. 1). The collected information may include the following information:
From S-AF 213: Sensing requirements, e.g. targeted area, targeted direction, targeted objects, sensing performance requirements, may be collected from the S-AF 213.
From C-AF 214: Communication requirements, e.g., QoS requirements, type of service, are collected from the C-AF 214. In addition, relative priorities between communication and sensing requirements may also be specified, e.g. by the network operator. These relative priorities may be used to decide to what degree the excess communication performance (i.e. beyond the minimum requirement) is sacrificed in favor of sensing performance.

For instance, the C-AF 214 may be able to specify a GBR threshold which specifies the minimum required throughput of the communication flow. Any excess throughput (beyond the GBR level) may be sacrificed for the sake of facilitating sensing/improving sensing performance. In order to do this, for each candidate beam adjustment (considered to facilitate a sensing task), an estimate may be made of the resulting gain, the resulting SINR and the resulting user throughput. Optionally, also the intra/inter-cell interference impact may be included in the analysis. A compiled list of all such candidate beam adjustments along with their performance impact may then be used as a basis for selecting the optimal beam for a specific sensing task, which is acceptable from the perspective of the possible GBR requirements of on-going communication tasks.

Another example of a threshold that C-AF 214 may be able to specify is the required latency (e.g. for URLLC applications). For each candidate beam adjustment (considered to facilitate a sensing task), the estimated SINR (see above) and corresponding MCS may be used to estimate the time to transmit a certain amount of data. As above, a compiled list of candidate beam adjustments and their latency impact may be used as a basis for selecting the preferred beam adjustment, taking into account the relative priorities between the communication and sensing tasks and the possible latency requirements of the communication tasks.
From local information 236: Information regarding the amount of available resources at the BS 231 (e.g. power, spectrum), relevant base station constraints (e.g. beamforming flexibility of the antenna arrays), etc. may be stored and collected locally at the BS 231.
From UEs 223: The information collector 235 may rely on already available information at the BS 231 that is collected for a different purpose. For instance, the channel state information (CSI) of the UEs 223 (which includes RSRP, CQI, PMI, RI reports) collected for UE mobility, for determining beamforming parameters and MCS, and/or for mitigating interference may be used. The information collection could be event-triggered (e.g. handover), or periodic. If required information is not available at the BS 231, the information collector 235 may transmit requests for new information (e.g. CSI) to all UEs or to a selected group of UEs. In the latter case, the UEs may be selected on UE locations, for example. For instance, UEs (both active and idle) located in the target sensing area may be selected.
From neighboring base stations (not shown in FIG. 9): Information from neighboring base stations regarding the use of spectrum may be collected for interference awareness and interference cancellation at the sensing BS 231. For instance, it is helpful to know the power of the transmitted signals from the neighboring base station at a given PRB/carrier to deduct the interference at the sensing BS 231.

The interface between the S-AF 213 and the information collector 235 is preferably standardized. How this interface is standardized could depend on:
how the information on sensing requirements is collected. There are two main options for collecting this information from the S-AF 213, which are:
1. Information is pushed by the S-AF 213 to the BS 231 via the information collector 235, e.g., for a specific sensing task the S-AF 213 forwards the requirements to a pre-assigned BS, e.g. BS 231, to carry out the sensing. If there is an update in the requirements of on-going sensing task, the update can be pushed to the assigned BS, e.g. BS 231. This is the preferred option:
2. Information is pulled from the S-AF 213 by the information collector 235, e.g., BS 231 may proactively/regularly check the updates in requirements.
how the sensing measurements collected by the sensing data collector 234 are shared with S-AF 213 (optionally via the information collector 235). There are two main options:
1. Sensing data collector 234 shares raw data, e.g., if BS 231 is a simple base station which has insufficient processing capability (e.g. in absence of a dedicated sensing data processor 233) or when raw data of multiple base stations need to be fused/combined or otherwise jointly processed. In this implementation, the BS 231 enables the S-AF 213 to determine the one or more physical properties of the one or more sensed objects. In this implementation, the S-AF 213 is a data processing system which determines the one or more physical properties of each of the one or more objects based on the characteristics of the received signals obtained by the BS 231. For example, sensing data processor 233 may be included in S-AF 213 instead of in BS 231;
2. Sensing data collector 234 shares (semi-) processed data, e.g., if the BS 231 has sufficient processing capability (e.g. when there is a dedicated sensing data processor 233 as shown in FIG. 9) or in the case of limited backhaul capacity. In this implementation, the processor 233 of BS 231 determines the one or more physical properties of each of the one or more objects based on the characteristics of the received signals.

The interface between the C-AF 214 and the BS 231 may be 3GPP compliant (e.g. LTE, 5G). Considering 5G technology, assuming a Protocol Data Unit (PDU) session is already active, a device-terminating (in other words: network-originating) QoS flow establishment has the following steps: (i) the C-AF 214 first submits the flow establishment request to the Policy Control Function (PCF) 215: the PCF 215 acts as the coordinator in the flow establishment and (ii) checks via the Session Management Function (SMF) 216 with the BS 231 for admissibility from a RAN perspective and with the User Plane Function (UPF) 217 for admissibility from a core network perspective. As part of the process, the BS 231 will page the targeted UE, e.g. one of UEs 223, to establish a signaling connection, aiding in the admissibility check. In the case of a device-originating QoS flow establishment, the UE first establishes a signaling connection and then signals its QoS flow establishment request to the PCF 215, which again coordinates the process in the same way as done for the case of establishing a device-terminating QoS flow.

Based on the collected information, the radio resource manager 237 performs step 105 of the method of FIG. 1 by taking scheduling and beam management decisions. These decisions are used by the BS 231 to perform step 107 of FIG. 1. Next, the sensing data collector 234 performs step 109 of FIG. 1 and the sensing data processor 233 then performs step 111 of FIG. 1. Optionally, the BS 231 performs step 113 of FIG. 1.

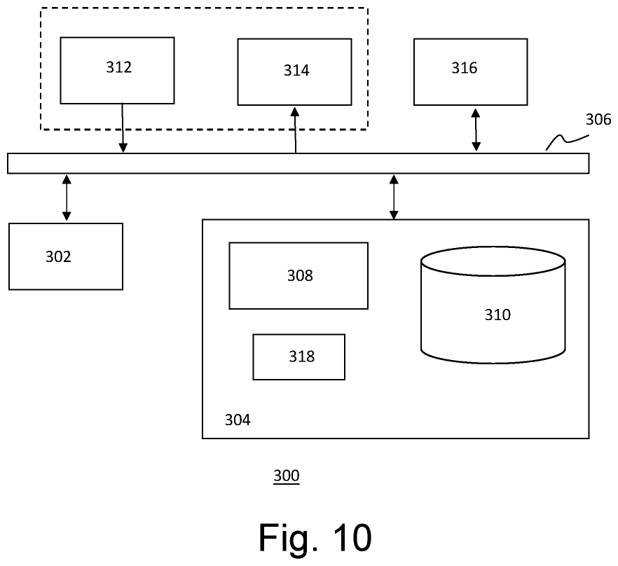

FIG. 10 depicts a block diagram illustrating an exemplary data processing system that may perform the method as described with reference to FIG. 1.

As shown in FIG. 10, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the number of times program code must be retrieved from the bulk storage device 310 during execution.

Input/output (I/O) devices depicted as an input device 312 and an output device 314 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 10 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 10, the memory elements 304 may store an application 318. In various embodiments, the application 318 may be stored in the local memory 308, he one or more bulk storage devices 310, or separate from the local memory and the bulk storage devices. It should be appreciated that the data processing system 300 may further execute an operating system (not shown in FIG. 10) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for sensing one or more objects based on characteristics of received signals, the system including:
at least one receiver;
at least one transmitter; and
at least one processor configured to:
obtain sensing requirements for sensing the one or more objects,
schedule frequency and time resources and/or determine beam characteristics of beams for transmissions of wireless communication signals to a specific further system based on the sensing requirements, the wireless communication signals including communication payload data,
transmit, via the at least one transmitter, the wireless communication signals to the further system on the scheduled frequency and time resources and/or via the beams with the determined beam characteristics,
upon transmitting the wireless communication signals, obtain received signals via the at least one receiver, the received signals comprising received versions of the transmitted wireless communication signals, the received signals reflecting an impact of the one or more objects on the transmitted wireless communication signals, and
determine, or enable to determine, one or more physical properties of each of the one or more objects based on the characteristics of the received signals.

2. A system as claimed in claim 1, wherein the at least one processor is configured to obtain information indicative of a cell load and schedule the frequency and time resources further based on the cell load and/or determine the beam characteristics further based on the cell load.

3. A system as claimed in claim 1, wherein the sensing requirements specify at least one of: one or more targeted areas, one or more targeted directions, one or more targeted objects, targeted object velocities, targeted object sizes, and a sensing accuracy.

4. A system as claimed in claim 3, wherein the sensing requirements specify targeted object velocities and the at least one processor is configured to determine a periodicity of the frequency and time resources based on the targeted object velocities.

5. A system as claimed in claim 3, wherein the sensing requirements specify targeted object sizes and the at least one processor is configured to determine an operating frequency of the frequency and time resources based on the targeted object sizes.

6. A system as claimed in claim 1, wherein the at least one processor is configured to schedule the frequency and time resources and/or determine the beam characteristics further based on communication requirements.

7. A system as claimed in claim 6, wherein the at least one processor is configured to select a candidate beam from a plurality of candidate beams based on the communication requirements and the sensing requirements and determine the beam characteristics of one of the beams by selecting beam characteristics of the selected candidate beam.

8. A system as claimed in claim 1, wherein the at least one processor is configured to determine a beamwidth and/or a beam direction for each of the beams based on the sensing requirements.

9. A system as claimed in claim 1, wherein the at least one processor is configured to determine a transmit power for each of the beams based on the sensing requirements.

10. A system as claimed in claim 1, wherein the at least one processor is configured to jointly determine beam characteristics for at least two of the beams based on the sensing requirements and/or jointly determine multiple beam characteristics per beam for at least one of the beams based on the sensing requirements.

11. A system as claimed in claim 1, wherein the at least one processor is configured to determine a first lobe of at least one of the beams based on communication requirements and a second lobe of the at least one of the beams based on the sensing requirements.

12. A system as claimed in claim 1, wherein the at least one processor is configured to select a frequency bandwidth based on the sensing requirements and/or select contiguous or non-contiguous frequency resources in dependence on the sensing requirements.

13. A system as claimed in claim 12, wherein the sensing requirements specify a targeted range resolution and the at least one processor is configured to select a first frequency bandwidth and/or contiguous frequency resources if the targeted range resolution does not exceed a threshold and select a second frequency bandwidth and/or non-contiguous frequency resources if the targeted range resolution exceeds the threshold, the first frequency bandwidth being smaller than the second frequency bandwidth and the contiguous frequency resources occupying a smaller spectral span than the non-contiguous frequency resources.

14. A system as claimed in claim 1, wherein the at least processor is configured to:
transmit, via the at least one transmitter, further wireless signals, the further wireless signals including dedicated sensing signals,
upon transmitting the further wireless signals, obtain further received signals via the at least one receiver, the further received signals comprising received versions of the transmitted further wireless signals, the further received signals reflecting an impact of the one or more objects on the transmitted further wireless signals and
determine, or enable to determine, the one or more physical properties of each of the one or more objects further based on characteristics of the further received signals.

15. A system as claimed in claim 14, wherein the at least one processor is configured to obtain information indicative of a cell load and transmit the further wireless signals in dependence on the cell load.

16. A data processing system for determining one or more physical properties of each of one or more objects, the data processing system including at least one processor configured to:
receive sensing data from the system of claim 1 the 15, said sensing data comprising characteristics of the received signals obtained by the system, and
determine the one or more physical properties of each of the one or more objects based on the characteristics of the received signals.

17. A telecommunications network comprising the system of claim 1 and a data processing system.

18. A method of sensing one or more objects based on characteristics of received signals, the method including:
obtaining sensing requirements for sensing the one or more objects and information indicative of a cell load;
scheduling frequency and time resources for and/or determining beam characteristics of beams for transmissions of wireless communication signals to a specific further system based on the sensing requirements and the cell load, the wireless communication signals including communication payload data;
transmitting the wireless communication signals to the further system on the scheduled frequency and time resources and/or via the beams with the determined beam characteristics;
upon transmitting the wireless communication signals, obtaining received signals, the received signals comprising received versions of the transmitted wireless communication signals, the received signals reflecting an impact of the one or more objects on the transmitted wireless communication signals; and
determining, or enabling to determine, one or more physical properties of each of the one or more objects based on the characteristics of the received signals.

19. A non-transitory computer-readable medium having instructions stored thereon, the instructions, when run on a computer system, being configured for performing the method of claim 18.
